(19) United States
(12) Patent Application Publication
(10) Pub. No.: US 2025/0299133 A1
(43) Pub. Date: Sep. 25, 2025

(54) SYSTEMS AND METHODS FOR GENERATING APPLICATIONS AND WORKFLOWS FOR ENTERPRISE TASKS

(71) Applicants: Souvik Sen, Sunnyvale, CA (US); Surojit Chatterjee, Los Altos, CA (US)

(72) Inventors: Souvik Sen, Sunnyvale, CA (US); Surojit Chatterjee, Los Altos, CA (US)

(73) Assignee: Ema Unlimited Inc., Mountain View, CA (US)

(21) Appl. No.: 18/610,276

(22) Filed: Mar. 20, 2024

(51) Int. Cl. G06Q 10/0633; G06N 3/08

(52) U.S. Cl. CPC G06Q 10/0633; G06N 3/08

(57) ABSTRACT

Systems and methods for using simple and unstructured conversational input, which is a part of an interactive conversation between a user and a system, to automatically generate a workflow for performing an enterprise task is described. The methods include generating a configurable application that includes the workflow, which when executed, performs the enterprise task. A simple conversational input, which is unstructured data, is processed to determine a task to be performed and a persona that will be performing such a task. Deep learning techniques are applied to leverage related data in the same domain from a knowledge base, that is associated with a foundational transformer model. A workflow involving a plurality of steps is automatically generated in-real time, based on the leveraged learning, while the interactive conversation is still in progress. A user interface that displays both the generated workflow and the input conversation is generated.

### FIELD OF INVENTION

Embodiments of the present disclosure relate to using simple and unstructured conversations to automatically generate applications, workflows, and user interfaces for enterprise tasks. They also relate to providing a persona template that is automatically configured for a type of user for performing the enterprise task or using the generated application.

### BACKGROUND

Enterprises generate their own custom software applications for a variety of tasks that are to be completed. These applications may be specific to a task or a department, such as accounting software application, human resources application, sales tracking application etc. In some cases, enterprises buy licenses to applications from third parties and then configure and customize the applications to their needs.

Generating an application is a cumbersome, time consuming, and expensive endeavor. In some cases, it requires the enterprise to hire coders, such as coders that may be familiar with various software programming languages (e.g., SQL, Python, Apex, C++, Java, Ruby etc.). Personnel at the enterprise that are tasked with generating such applications, such as project managers, technical program managers, etc., may have to devote several hours to put a team together that can determine the architecture, strategy, flow, and several other nuances to ensure that the application is designed to work in an intended manner. Personnel at the enterprise may also chose to hire outside consultants to develop the application, especially if the enterprise does not have employees that are skilled in building an application or if the enterprise is not in the business of building an application, which may also turn out to be expensive.

The task is still not completed once the application design is completed. There are serval hours devoted to testing the application. There may be different types of functional testing and non-functional testing that needs to be performed. Several UX and performance issues with the application may also have to be corrected to ensure a fully functional application.

Building an application may be especially challenging for smaller enterprises or enterprises whose core function or expertise is not in application building. For example, a pharmacy may need an application for tracking prescription refills and informing customers but may not have any expertise or internal resources to build a software application that allows then to perform that task. As such, they may end up buying an existing application, which may not be suitable for them, or hire a third party to generate an application for them.

As such, there is a need for more efficient and less cumbersome methods and systems for performing enterprise tasks, including by generating applications and their workflows for performing the enterprise task.

### BRIEF DESCRIPTION OF THE DRAWINGS

The various objects and advantages of the disclosure will be apparent upon consideration of the following detailed description, taken in conjunction with the accompanying drawings, in which like reference characters refer to like parts throughout, and in which:

FIG. 1 is a flowchart of an example of a process for using a conversational input to generate a workflow and a related customized and configurable persona template to perform an enterprise task, in accordance with some embodiments of the disclosure;

FIG. 2 is a block diagram of an example of a system for using a conversational input to generate a workflows, applications, and related customized and configurable persona template to perform an enterprise task, in accordance with some embodiments of the disclosure;

FIG. 3 is a block diagram of an example of an electronic device or user device for receiving a conversational input and displaying a user interface that can be used to perform an enterprise task or execute the workflow, in accordance with some embodiments of the disclosure;

FIG. 4 is flowchart of an example of a process for using a conversational input and a transformer model to generate a workflow, a user interface, and a related customized and configurable persona template to perform an enterprise task, in accordance with some embodiments of the disclosure;

FIG. 5 is flowchart of an example of a process for using a conversational input to generate a workflow and perform an enterprise task, in accordance with some embodiments of the disclosure;

FIG. 6 is a block diagram of a knowledge base that may be created or accessed for generating a workflow, in accordance with some embodiments of the disclosure;

FIG. 7 is a block diagram of automatically updating a workflow based on error detection, in accordance with some embodiments of the disclosure;

FIG. 8 is a block diagram of a user interface for simultaneously displaying an interactive conversation and the generated workflow, in accordance with some embodiments of the disclosure;

FIG. 9 is an example of sub-workflows and steps involved in the sub-workflows to perform an enterprise task, in accordance with some embodiments of the disclosure;

FIG. 10 is an example of types of data that may be gathered by the system to generate a persona template, in accordance with some embodiments of the disclosure;

FIG. 11 is flowchart of an example of a process for using a conversational input to generate a workflow for a pharmacy assistant and perform a pharmacy related task, in accordance with some embodiments of the disclosure; and

FIG. 12 is an example of a persona template, in accordance with some embodiments of the disclosure.

### DETAILED DESCRIPTION

In accordance with some embodiments disclosed herein, the above-mentioned limitations are overcome by using simple and unstructured conversations to automatically generate workflows for performing an enterprise task. In some embodiments, the workflows generated may be used to perform a task in a specific domain (e.g., healthcare, finance, accounting, human resources). In yet other embodiments, the workflows may be part of an executable enterprise application that when executed perform the steps in the workflow, for a particular persona, to complete an enterprise task and provide an output in a format that is understood by the persona.

The above-mentioned limitations are also overcome by using the generated workflow to generate and provide a configurable application, also referred to herein, in some embodiments, as a persona template. Interactive conversation between a user and the system may occur for the system to learn, among other information, the user's persona, the task to be performed, the industry related to the task, and how the user wishes to use the configurable application to perform the task. The interactive conversation may be between an automatically generated AI agent, which may be generated by the generative AI system using the control circuitry. The system may use the learned information, leveraging a knowledge base associated with a transformer model, and generate a workflow for performing the task based on the learned information and data leveraged from knowledge base. Using the learned information and data leveraged from knowledge base, the system may also generate a persona template customized for the user. The system may further cause to display a user interface that allows the user to continue the interactive conversation and visualize both the generated workflow and the persona template.

In further detail, in some embodiments, the disclosed embodiments provide methods and systems that utilize machines, or teach machines, using foundational transformer models, to generate a generate applications and generate workflow for completing a task. The tasks may be simple or complex and require several steps. The task may also be in a specific domain/industry. An example of a specific task may be to generate a software application for onboarding new employees. Another example of a task may be to generate a task for the enterprise to comply with a new regulation that is specific to the enterprise. Whatever the task may be, in some embodiments, the task may be something new that has not been done before. In an alternative embodiment, the task may be something done before, such as at another enterprise; however, it may not be directly applicable to the current enterprise since, for example, the policies and rules of the current enterprise differ from other enterprises. In another example, although the task at a high level may be a task performed at previously, such as by someone else, implementation of an application to perform such a task may differ from the previous implementations. For example, the implementation may require the current enterprise to access different databases, use different methods to obtain authorizations and access to such databases, and execute several different processes and perform different steps than another enterprise. As such, the challenge faced, which is addressed by the disclosed embodiments, may be to come up with a workflow solution that is unique and deployable at the current workplace or enterprise to compete the task.

Previous steps used to perform the task may differ from one person to another or one enterprise to another. Since one of the goals of the system is not to copy steps used by others in performing the task, the embodiments disclosed herein do not try to find a matching solution in the knowledge base to then copy the solution for performing the current task. To the contrary, since the current needs of the enterprise differ, the problems to solve at the current enterprise differ, the task to be performed differs, the implementation differs, if it were to simply look for existing solutions to match, such an approach would not work for the newer tasks or problems, such as of the current enterprise, especially when the data structures, locations of data, policies and procedures, implementations, and other elements may greatly differ for the current enterprise than previous approaches.

Instead, the approaches described herein trains the transformer model based on data in the same domain (e.g., industry) as the current task. It may also train the transformer model based on data that is related to other approaches taken. Such training data is then stored in the knowledge base associated with the transformer model. The system learns intuitively from the knowledge base to develop new approaches, strategies, implementations, etc. to generate a new workflow for solving the problem or performing a task for the current enterprise. To state in other words, the workflow generated in part and as a whole may be generated based on intuitive learning and leveraging of data from the knowledge base and other sources.

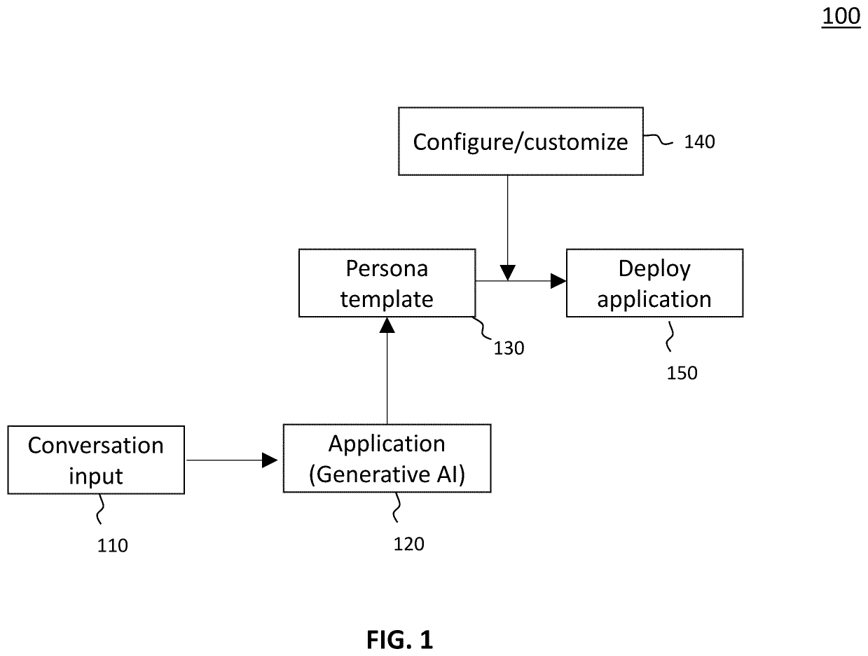

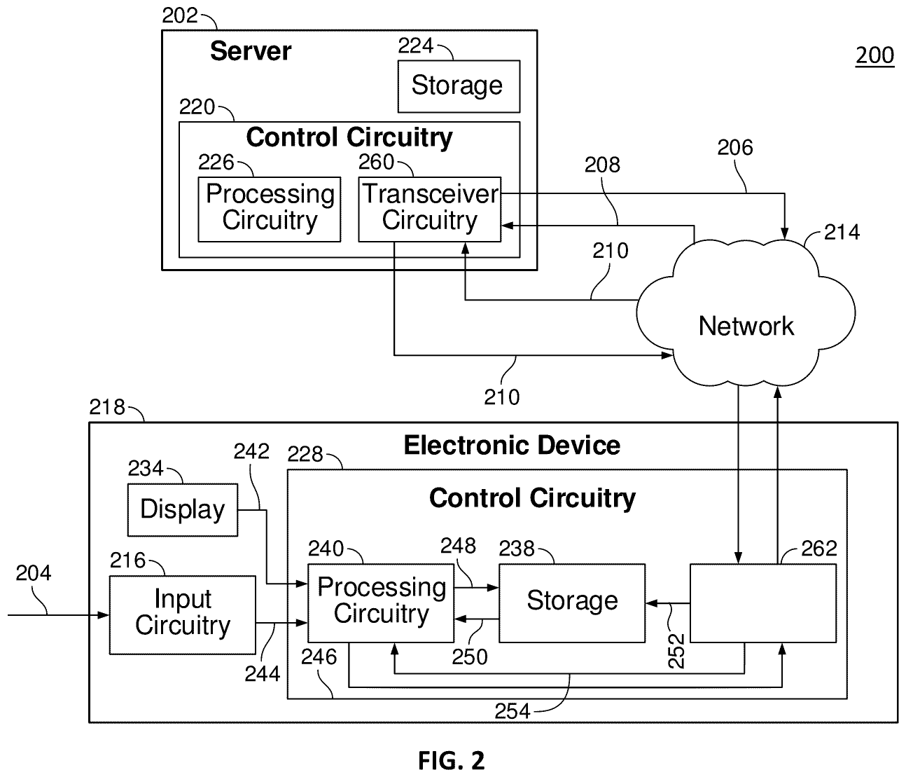

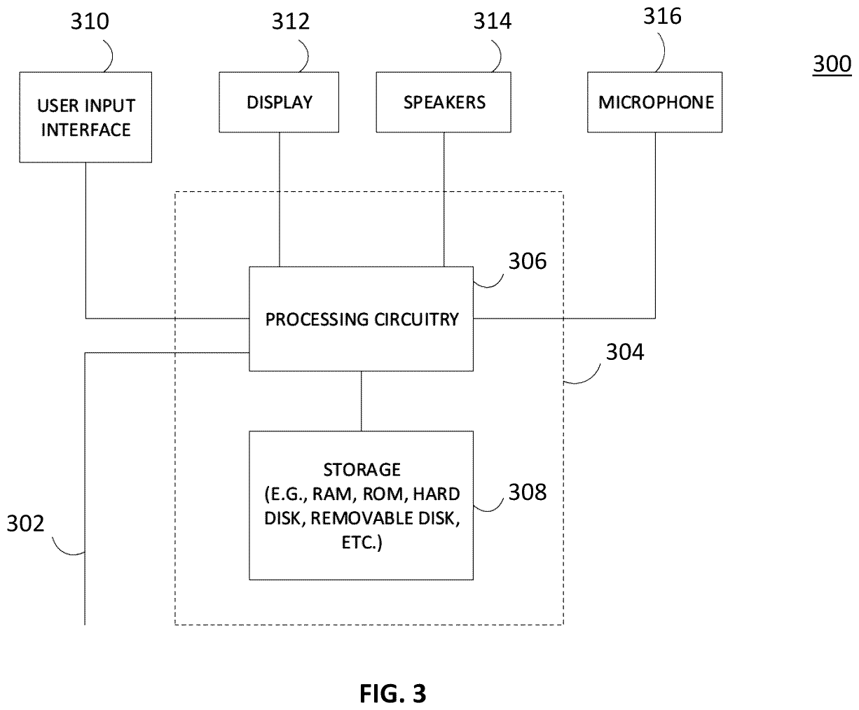

Turning now to figures, the process 100, as depicted in FIG. 1, may be implemented, in whole or in part, by systems or devices such as those shown in FIGS. 2-3. One or more actions of the process 100 may be incorporated into or combined with one or more actions of any other process or embodiments described herein. The process 100 may be saved to a memory or storage (e.g., any one of those depicted in FIGS. 2-3) as one or more instructions or routines that may be executed by a corresponding device or system to implement the method 100.

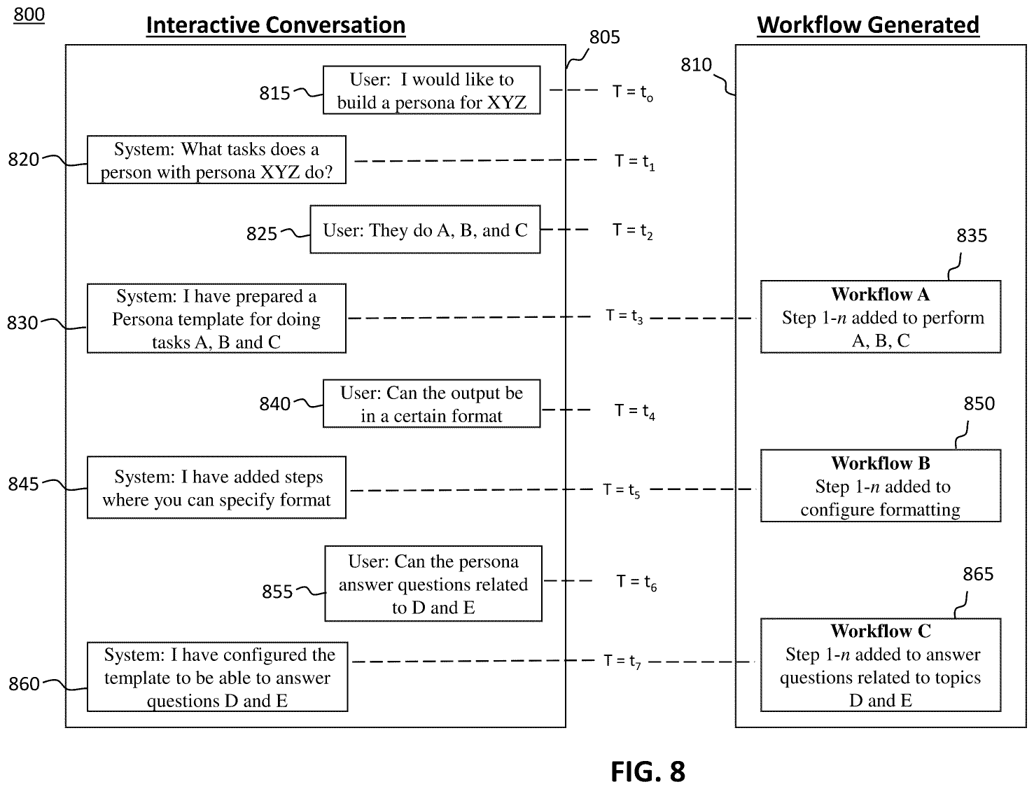

In some embodiments, the process may be initiated by receiving a conversational input, such as input depicted at block 110 in FIG. 1, block 410 in FIG. 2, block 510 in FIG. 3, and/or block 815 in FIG. 8. The input may be received via keyboard, touchscreen, gesturing, or may be a voice input. The input may be an unstructured input, such as “generate an application for onboarding employees.” In other words, the input may not include instructions that are detailed to a level of coding, step-by-step design and architecture of the application, or a flowchart of how steps are to be executed. It may be a simple conversational input. In some embodiments, the user providing the task and the instructions may be a layman not skilled in the art of generating applications or workflows. In other embodiments, the input may include more specifics that may be used to generate an application. For example, “generate an application for onboarding employees; design the application using C++ and Python languages; provide configuration tools that can be managed by a person having XYZ skill set.” In such instances, although the conversational input provides more specifics than the earlier example, it may still be at a high level in which step-by-step instructions, steps, processes, implementations, or details to the architectural level are not provided. Even if some details are provided, the implementations, design, strategy may still need to be analyzed without user intervention. As such, conversational input that range from simple to more complex are both contemplated within the embodiments.

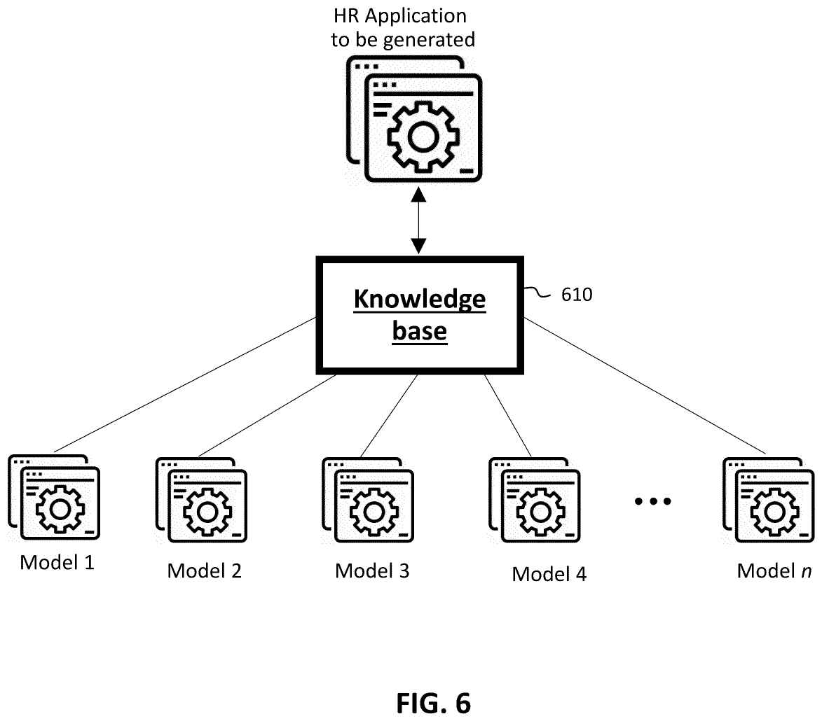

In yet other embodiment, the conversation may be an interactive conversation (as depicted in FIG. 8) between the user and the system (or the user and an AI agent or bot generated by the system), such as the system depicted in FIG. 2. In this embodiment, the user or the system may initiate the interactive conversation and as the conversation progresses, related workflow may be generated simultaneously, taking into account any network lag, as depicted in FIG. 8. The interactive conversation may include a user asking a question, requesting a task to be performed, or providing instructions. The system would then respond automatically on steps taken by the system to perform the task requested. The system may also query the user for additional information that may be used in generating a workflow for performing the task. The question prompted by the system or the workflows built simultaneously by the system are done so automatically based on learning from the knowledge base (depicted at FIG. 6) associated with a transformer model and may not involve any user intervention. In some embodiments, simultaneously generating and displaying the workflow may comprise generating the workflow in a backend in real-time (taking into account any network delays) during progress of the interactive conversation and displaying the generated workflow simultaneously during progress of the interactive conversation. In yet more embodiments, simultaneously generating and displaying the workflow may comprise receiving a first conversational input from the user, such as input 825 in FIG. 8 for performing task A, B, and C. The first conversational input may be an input associated with the interactive conversation 805. Displaying the workflow generated on a user interface of the user, such as workflow A 835. The workflow 835 generated relating to a topic of the first conversational input 825 is displayed simultaneously while providing a response to the first conversational input, such as the response 830 and is displayed before receiving a second conversational input 840 from the user. In yet other embodiments, if the second conversational input is on the same topic as the first conversational input, then both may be addressed together and the related workflow may be shown simultaneously.

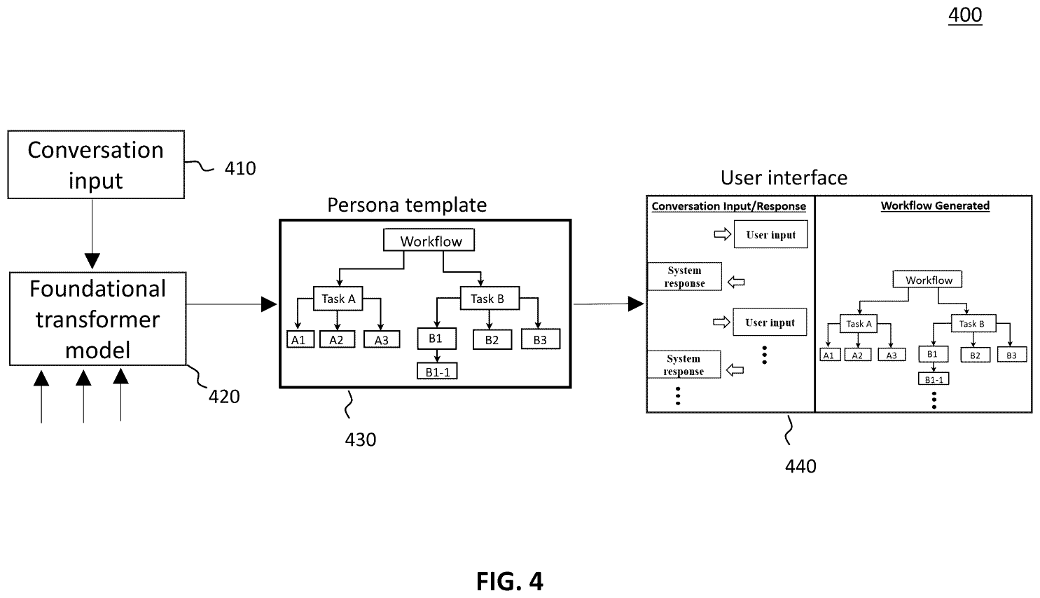

At block 120, the control circuitry, such as the control circuitry 220 and/or 228 of FIG. 2 may access a generative artificial intelligence (AI) application or an AI engine that is associated with one or more large scale language models (LLMs). This generative AI application may access a foundational transformer model which includes a knowledge base, such as the foundational transformer model 420 of FIG. 4 that accesses the knowledge base 610 of FIG. 6.

The knowledge base may already be created or may need to be generated. The knowledge base may be a storage location for the transformer model to store data on which it has been trained. In some embodiments, the foundational transformer model may have been trained based on data relevant to the task or the domain (e.g., industry). For example, if the task is to generate an application for onboarding employees and it is to be used by human resources (HR) of an enterprise, the foundational transformer model may already have been trained with tens, hundreds, thousands of employee onboarding applications that exist in the industry, or exist within the enterprise and are not publicly available. It may also have been trained generally with data relating to HR onboarding from a plurality of sources, such as courses, videos, webpages, books, and any type of secondary materials that relates to HR and/or specifically to onboarding employees.

In some embodiments, the foundational transformer model may be trained using a plurality of other models, such as models 1-n depicted in FIG. 6. In this embodiment, data from models 1-n may be fed as input into the foundational transformer model. The foundational transformer model may store the fed data into the knowledge base 610. Since each model may have different data relating to the task to be performed, which may also include processes and steps used to perform the task, the generative AI application may access all such data from the knowledge base of the foundational transformer model to learn, such as by applying deep learning techniques, and develop the workflow 430. In the event the foundational transformer model is not trained with data relevant to the task to be performed or the domain, it may automatically seek out relevant data from any and all sources that are accessible (i.e., both public and private sources).

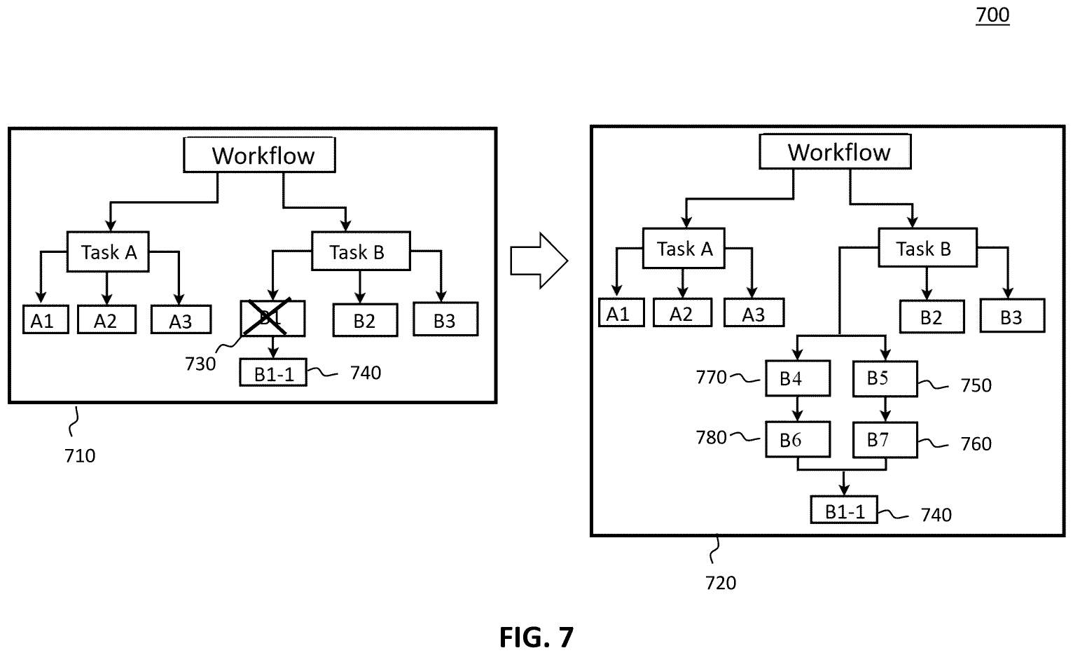

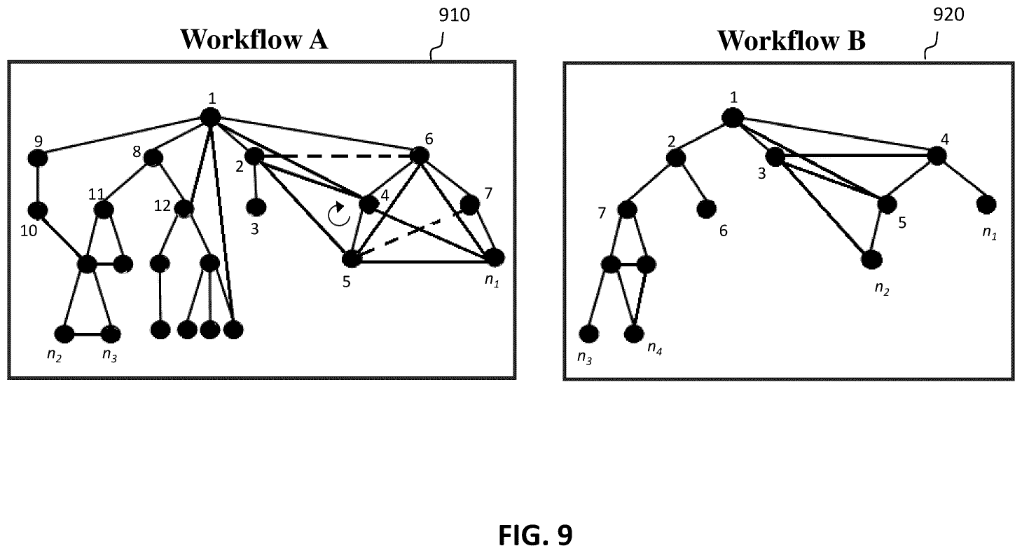

The workflow, as referred to herein, in some embodiments, may be a series of steps taken to perform the enterprise function. These steps may include accessing certain databases, analyzing certain types of data, obtaining permissions and authorizations to access the data, generating code, performing calculations, determining workflow strategy, determining implementation steps, performing debugging of code, and any other action required to perform the task requested by the user. Since the task may be to generate an application for performing a plurality of tasks in the same genre, such as an application that would help an HR assistant answer all HR related questions received from employees, each step in the workflow generated may require one or more steps or processes to be executed. Although it may be represented a single workflow step in a user interface to the user performing the task, executing each single workflow step may involve executing a plurality of complex processes, nested steps, testing each step of the process, repeating certain steps as needed, or revising the workflow step to proceed to a next step in the workflow. Some examples of series of steps and processes for a single workflow step are depicted in FIGS. 7 and 9.

Using the previous example, if the current task to be performed, based on the simple conversational input received, is an employee onboarding application, deep learning techniques using artificial neural networks to analyze and perform computations on large amounts of data may be applied to access and learn from the knowledge base 610 associated with the foundational transformer model 420 to then generate a workflow for performing the task. The generated workflow may have several workflow steps, such as obtaining employee data, performing background checks of the employee, setting up the employee with benefits, configuring payment options for employee paycheck, providing access to various departments, ordering ID and laptop, performing all the tasks on an onboarding checklist etc. Performing these tasks may involve executing several steps and processes that may differ from company to company. Although some commonality between the performing the onboarding employee task and data inputted into the knowledge base may exist, the design, strategy, computations, steps, processes, and implementation of the function may vary. For example, as discussed earlier, the policies, procedures, data storage repositories and libraries, including the type of data, how to access such data, and many other functions may vary. Accordingly, the workflow for performing onboarding of an employee for the current company may take into account all the different processes, policies, strategies, computations, steps, and implementation specific to the current company.

Referring back to block 120 of FIG. 1, once the workflow is generated, the control circuitry 220 and/or 228 may customize a persona template 130 that can be used by the user who will be using the generated workflow to perform the task or have the task performed.

The persona template may be designed based on the persona of the user that will be using the workflow or the application to perform the task or have it performed. The persona may relate to the user, their role, their tile, and/or their job function in the enterprise. For example, in a same enterprise, the persona may relate to a secretary, associate, manager, vice president, or CEO. Although the workflow to perform the task may be same, how its presented, and how its used may be customized to the persona.

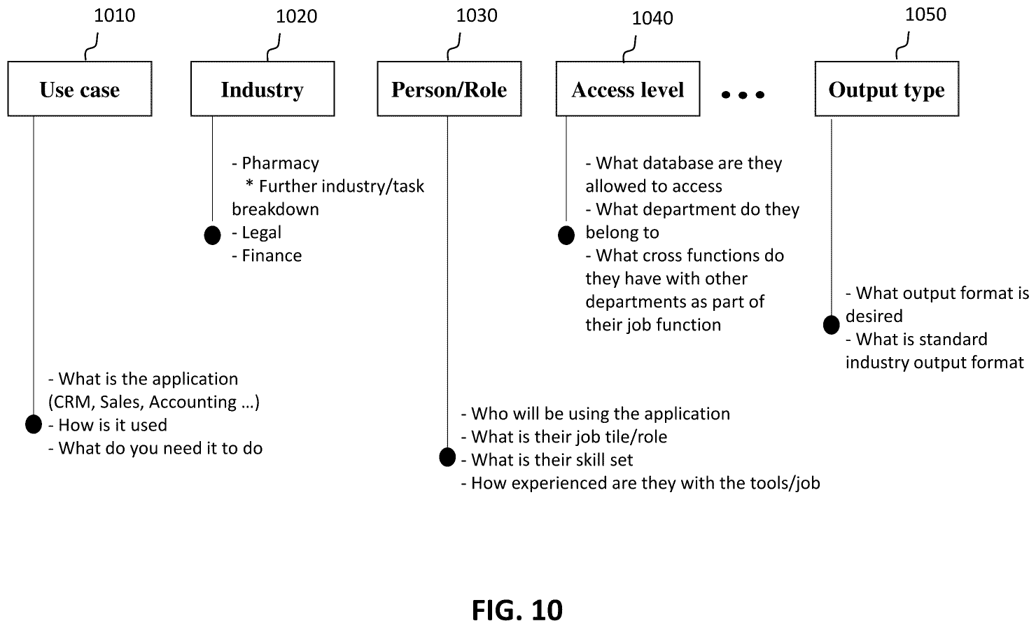

The persona template, in some embodiments, may be a software application. In some embodiments, the conversational input 110 may specify the type of persona to be used in creating the persona template. For example, as depicted in FIGS. 8 and 10, a persona may be specified or selected by a user. If the user does not specify the persona, the control circuitry 220 and/or 228 may automatically determine the persona. In some embodiments, the control circuitry 220 and/or 228 may analyze the conversational input to determine the persona. For example, if the conversational input states “I want an application to manage my business travel expenses while I am on my sales trips,” the control circuitry 220 and/or 228 may determine based on the conversational input that the persona should be a sales employee. In another example, if the conversational input states “I want something that would help me in my job in the pharmacy to inform people their refills are ready for pick up.” Based on the input, control circuitry 220 and/or 228 may determine the persona to be someone who works in a pharmacy. The control circuitry 220 and/or 228 may also determine persona based on other documents, emails, texts, online sources (e.g., LinkedIn) when it is not provided.

In some embodiments, to generate the persona template, the control circuitry 220 and/or 228 may obtain several pieces of data from the user, such as data described in FIG. 10. Such data may be obtained from the user during the conversational input and interaction. In some embodiments, the workflow model may be created before creating the persona template and in other embodiments, the workflow model may be created after creating the persona template or simultaneously while the persona template is being created.

At block 140, the user, using their persona template, may be able to configure or customize the workflow (or the application that includes the generated workflow). Such customizations may include inputting enterprise specific data, inputting enterprise specific procedures and policies, providing direction on format and output, providing input on how the result of the task should be presented, providing input relating to which other employees the output should be shared with, and any other customization desired.

At block 150, the application may be deployed or the workflow may be completed after customization for use by the intended persona. A user interface, such as user interface depicted at block 440 of FIG. 4, or FIG. 8, may be provided for the user to continue engaging in the interactive conversation and adding additional tasks or revising the task to be performed.

FIG. 2 is a block diagram of an example of a system for using a conversational input to generate a workflow and a related customized and configurable persona template to perform an enterprise task, in accordance with some embodiments of the disclosure and FIG. 3 is a block diagram of an example of an electronic device or user device for receiving a conversational input and displaying a user interface for use by a user to perform an enterprise task or execute the workflow, in accordance with some embodiments of the disclosure.

FIGS. 2 and 3 also describe exemplary devices, systems, servers, and related hardware that may be used to implement processes, functions, elements and components, and functionalities described in relation to FIGS. 1 and 4-12. Further, FIGS. 2 and 3 may also be used to receive conversational input, provide a platform for an interactive conversation, where the conversation is between a user and a system, such as a generative AI system that may be performed by an AI bot or AI agent, accessing a knowledge base associated with a transformer model, generating a knowledge base and a transformer model if one doesn't exists and training it with domain relevant data, applying deep learning techniques to learn from the data in the knowledge base, determining steps of a workflow needed to complete a task, an enterprise function, where the workflow provides a structure of a series of steps that when executed provide the answer, solution, or end product desired by the user, automatically and without user intervention generating the workflow for performing a task or enterprise function, generating persona template that can be used by a user to configure the workflow or equip the generated application that includes the workflow with enterprise or custom data, obtaining information from the user to determine persona, generating a user interface that displays the persona template, the interactive conversation, and the workflow generated, and performing all the functions, steps, features, discussed herein.

In some embodiments, one or more parts of, or the entirety of system 200, may be configured as a system implementing various features, processes, functionalities and components of FIGS. 1 and 4-12. Although FIG. 2 shows a certain number of components, in various examples, system 200 may include fewer than the illustrated number of components and/or multiples of one or more of the illustrated number of components.

System 200 is shown to include a computing device 218, a server 202 and a communication network 214. The system may be a generative artificial intelligence system that uses AI bots and agents. It is understood that while a single instance of a component may be shown and described relative to FIG. 2, additional instances of the component may be employed. For example, server 202 may include, or may be incorporated in, more than one server. Similarly, communication network 214 may include, or may be incorporated in, more than one communication network. Server 202 is shown communicatively coupled to computing device 218 through communication network 214. While not shown in FIG. 2, server 202 may be directly communicatively coupled to computing device 218, for example, in a system absent or bypassing communication network 214.

Communication network 214 may comprise one or more network systems, such as, without limitation, an internet, LAN, WIFI or other network systems suitable for audio processing applications. In some embodiments, system 200 excludes server 202, and functionality that would otherwise be implemented by server 202 is instead implemented by other components of system 200, such as one or more components of communication network 214. In still other embodiments, server 202 works in conjunction with one or more components of communication network 214 to implement certain functionality described herein in a distributed or cooperative manner. Similarly, in some embodiments, system 200 excludes computing device 218, and functionality that would otherwise be implemented by computing device 218 is instead implemented by other components of system 200, such as one or more components of communication network 214 or server 202 or a combination. In still other embodiments, computing device 218 works in conjunction with one or more components of communication network 214 or server 202 to implement certain functionality described herein in a distributed or cooperative manner.

Computing device 218 includes control circuitry 228, display 234 and input circuitry 216. Control circuitry 228 in turn includes transceiver circuitry 262, storage 238 and processing circuitry 240. In some embodiments, computing device 218 or control circuitry 228 may be configured as user device 300 of FIG. 3.

Server 202 includes control circuitry 220 and storage 224. Each of storages 224 and 238 may be an electronic storage device. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 4D disc recorders, solid state devices, quantum storage devices, or any other suitable fixed or removable storage devices, and/or any combination of the same. Each storage 224, 238 may be used to store various types of data (e.g., they can be used to store conversational inputs, user preferences such as formatting preferences, personas, workflows generated, user interface and its various elements, a knowledge base, persona templates and NLP, ML, and AI algorithms). Non-volatile memory may also be used (e.g., to launch a boot-up routine and other instructions). Cloud-based storage may be used to supplement storages 224, 238 or instead of storages 224, 238. In some embodiments, data relating to received conversational input, interactive conversation, knowledge base, training data, workflow generated, user interface and its various elements, a knowledge base, persona templates and NLP, ML, and AI algorithms, and data relating to all other processes and features described herein, may be recorded and stored in one or more of storages 212, 238.

In some embodiments, control circuitry 220 and/or 228 executes instructions for an application stored in memory (e.g., storage 224 and/or storage 238). Specifically, control circuitry 220 and/or 228 may be instructed by the application to perform the functions discussed herein. In some implementations, any action performed by control circuitry 220 and/or 228 may be based on instructions received from the application. For example, the application may be implemented as software or a set of executable instructions that may be stored in storage 224 and/or 238 and executed by control circuitry 220 and/or 228. In some embodiments, the application may be a client/server application where only a client application resides on computing device 218, and a server application resides on server 202.

The application may be implemented using any suitable architecture. For example, it may be a stand-alone application wholly implemented on computing device 218. In such an approach, instructions for the application are stored locally (e.g., in storage 238), and data for use by the application is downloaded on a periodic basis (e.g., from an out-of-band feed, from an internet resource, or using another suitable approach). Control circuitry 228 may retrieve instructions for the application from storage 238 and process the instructions to perform the functionality described herein. Based on the processed instructions, control circuitry 228 may determine a type of action to perform in response to input received from input circuitry 216 or from communication network 214. For example, in response determining the enterprise task to be performed deep learning techniques may be applied to access and learn from the knowledge base associated with the foundational transformer model to determine strategy, flow, and several other nuances for generating workflow for performing the enterprise task. To accomplish this, in one embodiment, the control circuitry 228 may perform the steps of process described at least in any one or more of FIGS. 1 and 4-12 and all the steps and processes described in all the figures depicted herein.

In client/server-based embodiments, control circuitry 228 may include communication circuitry suitable for communicating with an application server (e.g., server 202) or other networks or servers. The instructions for carrying out the functionality described herein may be stored on the application server. Communication circuitry may include a cable modem, an Ethernet card, or a wireless modem for communication with other equipment, or any other suitable communication circuitry. Such communication may involve the internet or any other suitable communication networks or paths (e.g., communication network 214). In another example of a client/server-based application, control circuitry 228 runs a web browser that interprets web pages provided by a remote server (e.g., server 202). For example, the remote server may store the instructions for the application in a storage device. The remote server may process the stored instructions using circuitry (e.g., control circuitry 228) and/or generate displays. Computing device 218 may receive the displays generated by the remote server and may display the content of the displays locally via display 234. This way, the processing of the instructions is performed remotely (e.g., by server 202) while the resulting displays, such as the display windows described elsewhere herein, are provided locally on computing device 218. Computing device 218 may receive inputs from the user via input circuitry 216 and transmit those inputs to the remote server for processing and generating the corresponding displays. Alternatively, computing device 218 may receive inputs from the user via input circuitry 216 and process and display the received inputs locally, by control circuitry 228 and display 234, respectively.

Server 202 and computing device 218 may transmit and receive data such as data relating to received conversational input, interactive conversation, knowledge base, training data, workflow generated, user interface and its various elements, persona templates, data related to employee job titles and designations, and NLP, ML, and AI algorithms.

Control circuitry 220, 228 may send and receive commands, requests, and other suitable data through communication network 214 using transceiver circuitry 260, 262, respectively. Control circuitry 220, 228 may communicate directly with each other using transceiver circuits 260, 262, respectively, avoiding communication network 214.

It is understood that computing device 218 is not limited to the embodiments and methods shown and described herein. In nonlimiting examples, computing device 218 may be a personal computer (PC), a laptop computer, a tablet computer, a personal computer television (PC/TV), a generative AI server, a handheld computer, a mobile telephone, a smartphone, or any other device, computing equipment, or wireless device, and/or combination thereof that can receive conversation inputs and process them to generate workflows as discussed.

Control circuitry 220 and/or 218 may be based on any suitable processing circuitry such as processing circuitry 226 and/or 240, respectively. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores). In some embodiments, processing circuitry may be distributed across multiple separate processors, for example, multiple of the same type of processors (e.g., two Intel Core i9 processors or Nvidia processors) or multiple different processors (e.g., an Intel Core i7 and i9 processors or Nvidia GH 100, 200).

In some embodiments, control circuitry 220 and/or control circuitry 218 are configured to receive conversational input, provide a platform for an interactive conversation, where the conversation is between a user and a system, such as a generative AI system that may be performed by an AI bot or AI agent, accessing a knowledge base associated with a transformer model, generating a knowledge base and a transformer model if one doesn't exists and training it with domain relevant data, applying deep learning techniques to learn from the data in the knowledge base, determining steps of a workflow needed to complete a task, an enterprise function, where the workflow provides a structure of a series of steps that when executed provide the answer, solution, or end product desired by the user, automatically and without user intervention generating the workflow for performing a task or enterprise function, generating persona template that can be used by a user to configure the workflow or equip the generated application that includes the workflow with enterprise or custom data, obtaining information from the user to determine persona, generating a user interface that displays the persona template, the interactive conversation, and the workflow generated, and performing all the functions, steps, features, discussed herein. Control circuitry 220 and/or control circuitry 218 are also configured to perform all processes described and shown in connection with FIGS. 1, 4, 5, 7, 8, 11, and 12.

Computing device 218 receives a user input 204 at input circuitry 216. For example, computing device 218 may receive a user input like perform task A, B, and C, such as in block 825 of FIG. 8.

Transmission of user input 204 to computing device 218 may be accomplished using a wired connection, such as an audio cable, USB cable, ethernet cable or the like attached to a corresponding input port at a local device, or may be accomplished using a wireless connection, such as Bluetooth, WIFI, WiMAX, GSM, UTMS, CDMA, TDMA, 3G, 4G, 4G LTE, 5G or any other suitable wireless transmission protocol. Input circuitry 216 may comprise a physical input port such as a 3.5 mm audio jack, RCA audio jack, USB port, ethernet port, or any other suitable connection for receiving audio over a wired connection or may comprise a wireless receiver configured to receive data via Bluetooth, WIFI, WiMAX, GSM, UTMS, CDMA, TDMA, 3G, 4G, 4G LTE, 5G, or other wireless transmission protocols.

Processing circuitry 240 may receive input 204 from input circuit 216. Processing circuitry 240 may convert or translate the received user input 204 that may be in the form of voice input into a microphone. In some embodiments, input circuit 216 performs the translation to digital signals. In some embodiments, processing circuitry 240 (or processing circuitry 226, as the case may be) carries out disclosed processes and methods. For example, processing circuitry 240 or processing circuitry 226 may perform processes as described in FIGS. 1, 4, 5, 7, 8, 11, and 12, respectively.

FIG. 3 is a block diagram of an example of an electronic device 300 used to provide a conversation input, receive a response to the conversational input, provide a platform for an interactive conversation, where the conversation is between a user and a system, such as a generative AI system that may be performed by an AI bot or AI agent, accessing a knowledge base associated with a transformer model, generating a knowledge base and a transformer model if one doesn't exists and training it with domain relevant data, applying deep learning techniques to learn from the data in the knowledge base, determining steps of a workflow needed to complete a task, an enterprise function, where the workflow provides a structure of a series of steps that when executed provide the answer, solution, or end product desired by the user, automatically and without user intervention generating the workflow for performing a task or enterprise function, generating persona template that can be used by a user to configure the workflow or equip the generated application that includes the workflow with enterprise or custom data, obtaining information from the user to determine persona, generating a user interface that displays the persona template, the interactive conversation, and the workflow generated, and performing all the functions, steps, features, discussed herein.

In an embodiment, the equipment device 300, is the same equipment device 202 of FIG. 2. The equipment device 300 may receive content and data via input/output (I/O) path 302. The I/O path 302 may provide audio content and data to control circuitry 304, which includes processing circuitry 306 and a storage 308. The control circuitry 304 may be used to send and receive commands, requests, and other suitable data using the I/O path 302. The I/O path 302 may connect the control circuitry 304 (and specifically the processing circuitry 306) to one or more communications paths. I/O functions may be provided by one or more of these communications paths but are shown as a single path in FIG. 3 to avoid overcomplicating the drawing.

The control circuitry 304 may be based on any suitable processing circuitry such as the processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 or Nvidia processors) or multiple different processors (e.g., an Intel Core i5, i7, i9 processor, Nvidia GH 100, 200).

The processes as described herein may be implemented in or supported by any suitable software, hardware, or combination thereof. They may also be implemented on user equipment, on remote servers, or across both.

In client-server-based embodiments, the control circuitry 304 may include communications circuitry suitable to receive conversational input, provide a platform for an interactive conversation, where the conversation is between a user and a system, such as a generative AI system that may be performed by an AI bot or AI agent, accessing a knowledge base associated with a transformer model, generating a knowledge base and a transformer model if one doesn't exists and training it with domain relevant data, applying deep learning techniques to learn from the data in the knowledge base, determining steps of a workflow needed to complete a task, an enterprise function, where the workflow provides a structure of a series of steps that when executed provide the answer, solution, or end product desired by the user, automatically and without user intervention generating the workflow for performing a task or enterprise function, generating persona template that can be used by a user to configure the workflow or equip the generated application that includes the workflow with enterprise or custom data, obtaining information from the user to determine persona, generating a user interface that displays the persona template, the interactive conversation, and the workflow generated, and performing all the functions, steps, features, discussed herein. The instructions for carrying out the above-mentioned functionality may be stored on one or more servers. Communications circuitry may include a cable modem, an integrated service digital network (ISDN) modem, a digital subscriber line (DSL) modem, a telephone modem, ethernet card, or a wireless modem for communications with other equipment, or any other suitable communications circuitry. Such communications may involve the internet or any other suitable communications networks or paths. In addition, communications circuitry may include circuitry that enables peer-to-peer communication of electronic equipment devices, or communication of electronic equipment devices in locations remote from each other (described in more detail below).

Memory may be an electronic storage device provided as the storage 308 that is part of the control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid-state devices, quantum-storage devices, or any other suitable fixed or removable storage devices, and/or any combination of the same. The storage 308 may be used to store conversational inputs, user preferences such as formatting preferences, personas, workflows generated, user interface and its various elements, a knowledge base, persona templates and NLP, ML, and AI algorithms. Cloud-based storage, described in relation to FIG. 3, may be used to supplement the storage 308 or instead of the storage 308.

The control circuitry 304 may include audio generating circuitry and tuning circuitry, such as one or more analog tuners, audio generation circuitry, filters or any other suitable tuning or audio circuits or combinations of such circuits. The control circuitry 304 may also include scaler circuitry for upconverting and down converting content into the preferred output format of the electronic device 300. The control circuitry 304 may also include digital-to-analog converter circuitry and analog-to-digital converter circuitry for converting between digital and analog signals. The tuning and encoding circuitry may be used by the electronic device 300 to receive and to display, to play, or to record content. The circuitry described herein, including, for example, the tuning, audio generating, encoding, decoding, encrypting, decrypting, scaler, and analog/digital circuitry, may be implemented using software running on one or more general purpose or specialized processors. If the storage 308 is provided as a separate device from the electronic device 300, the tuning and encoding circuitry (including multiple tuners) may be associated with the storage 308.

The user may utter instructions to the control circuitry 304, which are received by the microphone 316. The microphone 316 may be any microphone (or microphones) capable of detecting human speech. The microphone 316 is connected to the processing circuitry 306 to transmit detected voice commands and other speech thereto for processing. In some embodiments, voice assistants (e.g., Siri, Alexa, Google Home and similar such voice assistants) receive and process the voice commands and other speech.

The electronic device 300 may include an interface 310. The interface 310 may be any suitable user interface, such as a remote control, mouse, trackball, keypad, keyboard, touch screen, touchpad, stylus input, joystick, or other user input interfaces. A display 312 may be provided as a stand-alone device or integrated with other elements of the electronic device 300. For example, the display 312 may be a touchscreen or touch-sensitive display. In such circumstances, the interface 310 may be integrated with or combined with the microphone 316. When the interface 310 is configured with a screen, such a screen may be one or more monitors, a television, a liquid crystal display (LCD) for a mobile device, active-matrix display, cathode-ray tube display, light-emitting diode display, organic light-emitting diode display, quantum-dot display, or any other suitable equipment for displaying visual images. In some embodiments, the display 312 may be a 3D display. The speaker (or speakers) 314 may be provided as integrated with other elements of electronic device 300 or may be a stand-alone unit. In some embodiments, the display 312 may be outputted through speaker 314.

The equipment device 300 of FIG. 3 can be implemented in system 200 of FIG. 2 as electronic equipment device 202, but any other type of user equipment suitable for allowing communications between two separate user devices for performing the functions related to implementing machine learning (ML) and artificial intelligence (AI) algorithms, and all the functionalities discussed associated with the figures mentioned in this application

The electronic device 300 of any other type of suitable user equipment suitable may also be used to implement ML and AI algorithms, and related functions and processes as described herein. Various network configurations of devices may be implemented and are discussed in more detail below.

FIG. 4 is flowchart of an example of a process 400 for using a conversational input and a transformer model to generate a workflow, a user interface, and a related customized and configurable persona template to perform an enterprise task, in accordance with some embodiments of the disclosure. The process 400, as depicted in FIG. 4, may be implemented, in whole or in part, by systems or devices such as those shown in FIGS. 2-3. One or more actions of the process 400 may be incorporated into or combined with one or more actions of any other process or embodiments described herein. The process 400 may be saved to a memory or storage (e.g., any one of those depicted in FIGS. 2-3) as one or more instructions or routines that may be executed by a corresponding device or system to implement the method 400.

In some embodiments, process 400 receives a conversational input 410, leverages knowledge base associated with a foundational transformer model 420, and then automatically generates a workflow 430. The workflow generated may be enveloped in an application such that when the application is executed, the steps of the workflow are followed in a sequence, to then complete the task. The generated application is customized to a persona, such as a customer service representative, pharmacists etc. The process also automatically generates a user interface 440 based on the conversational input received. The user interface is generated without user intervention and provides tools to configure the generated application or the workflow. By doing so, the methods and systems perform all the analytical, computational, and process steps involved in taking a conversational input and generating at the other end a customizable software application without a need for coders, software architects, and several man hours to determine all elements of the software application. The methods and system (such as via the control circuitry 220 and/or 228 of FIG. 2) perform all the heavy lifting to determine a strategy and then generate workflow that can be used to complete the task or generate the software application that has the generated workflow to complete the task. The generated software application, which includes the workflow generated, performs the steps in the manner of the workflow when executed.

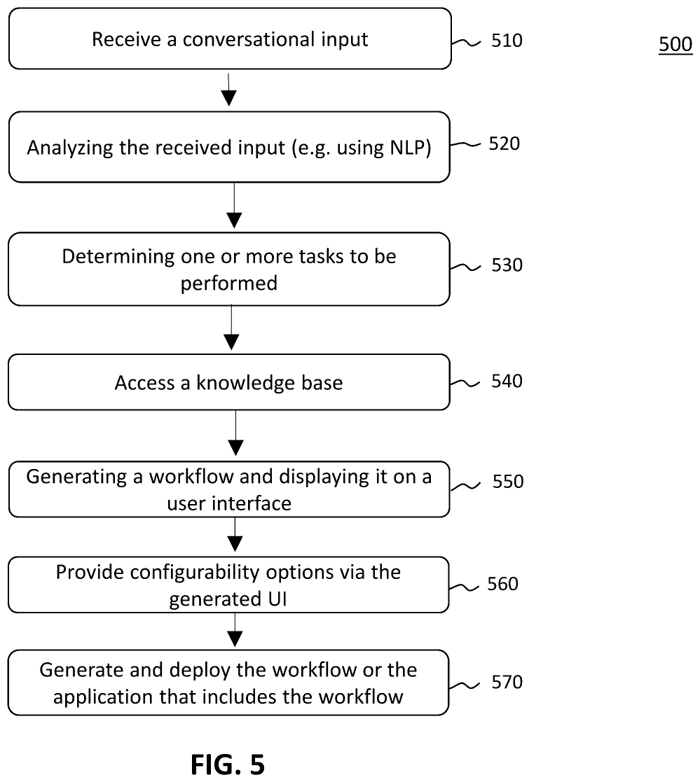

FIG. 5 is flowchart of an example of a process 500 for using a conversational input to generate a workflow and perform an enterprise task, in accordance with some embodiments of the disclosure. Process 500 may be implemented, in whole or in part, by systems or devices such as those shown in FIGS. 2-3. One or more actions of the process 500 may be incorporated into or combined with one or more actions of any other process or embodiments described herein. The process 500 may be saved to a memory or storage (e.g., any one of those depicted in FIGS. 2-3) as one or more instructions or routines that may be executed by a corresponding device or system to implement the method 500.

In some embodiments, a conversational input is received at block 510. The conversational input may be received via keyboard, touchscreen, or may be a voice input. The input may be an unstructured input, such as “perform task A and B,” or may include further direction, such as “perform task A and B, use data from database C, provide output in format D.” The conversational input, may also be interactive, such as the interactive conversation depicted in FIG. 8. Such an interactive conversation may include a conversation between the user and a generative AI system (or an AI agent/bot generated by the AI system) that responds to the user input.

At block 520, the received input may be analyzed using natural language processing (NLP) techniques. Such processing using NLP techniques may provide the generative AI system, such as the system or application at block 120, or the system of FIG. 2 using control circuitry 220 and/or 228 to perform the steps and functions, an understanding of what the user is asking/requesting, such as what question the user wants answered, what task the user wants performed etc. The generative AI system may ask follow-up questions as part of the interaction to get more details on the task to be performed. For example, the system may ask “what tasks does a person with persona of XYZ do,” as depicted at block 820 of FIG. 8.

At block 530, the system, such as system of FIG. 2, may determine one or more tasks, sub-tasks, or a layer of tasks or nested tasks, to be performed based on the conversational input or interactive conversation. Each task may require a plurality of steps that may include performing functions such as accessing certain databases, analyzing certain types of data, obtaining permissions and authorizations to access the data, performing certain calculations, generating code, performing calculations, determining workflow strategy, determining implementation steps, performing debugging of code, etc.

At block 540, the generative AI system may access, such as by using control circuitry 220 and/or 228, the knowledge base associated with the foundational transformer model. Deep learning techniques (e.g., classic, convolutional, recurrent neural networks or other types of deep learning techniques) may be applied to access and learn from the knowledge base associated with the foundational transformer model to determine strategy, flow, and several other nuances for generating workflow for performing the task determined at block 530.

At block 550, a workflow for performing the one or more tasks may be generated based on the learning from the knowledge base. The workflow model may be displayed on a user interface (UI) as depicted in FIG. 8 and block 440 of FIG. 4. The UI display may be in real-time (barring any network delays) as the conversational input occurs. For example, while the user is providing the conversational input, in the backend, the knowledge base may be accessed, determinations may be made, such as based on the learning from the knowledge base as to what type of workflow is required, and the workflow may be generated and displayed all simultaneously while the conversation is still occurring. In some embodiments, not only is the workflow generated, but it may also be tested and revised if any components of the workflow cannot be implemented.

At block 560, the generated UI may provide configuration options to the user to configure the generated workflow or the application that includes the workflow. The configuration options may be personalized and customized to the persona of the user. The generative AI system may obtain information from the user, determine on own, or determine based on secondary materials, such as emails, texts, and other information, the persona of the user. For example, if the user does not specify the persona during the interactive conversation, the control circuitry 220 and/or 228, since it may be provided access to the user's emails, texts, emails, documents, meetings, online accounts, employee files, HR databases, and other enterprise materials, may access such materials to automatically determine the persona.

At block 570, the workflow may be deployed such that it can be used by the user. If the workflow is enveloped in an application, the application may be ready for use by the user. In other words, the workflow may be used by the software application in its execution to perform the task provided.

FIG. 6 is a block diagram of a knowledge base that may be created or accessed for generating a workflow, in accordance with some embodiments of the disclosure. The knowledge base, in some embodiments, may include data that is relevant to the domain (e.g., e.g., healthcare, finance, accounting, human resources) or the specific task to be performed (e.g., onboard a new employee, answer patient questions relating to pills use at a pharmacy). The data may be inputted into the knowledge base from a plurality of sources. For example, input sources may include courses, videos, webpages and other online materials, books, libraries, models, applications, both public and private databases and resources, emails, texts, and any other data sources.

FIG. 7 is a block diagram of automatically updating a workflow based on error detection, in accordance with some embodiments of the disclosure. In some embodiments, the workflow created may be tested automatically by the generative AI system, such as by using control circuitry 220 and/or 228, to determine if its implementation causes any errors or has any issues.

In one example, a workflow 710 may be automatically created using the processes described herein, such as processes described in FIGS. 1, 4, 5 and 8. Upon automatic testing of the workflow, a determination may be made by the generative AI system that step B1 730 cannot be implemented. There may be many reasons for step B1 730 that may cause the implementation issue. For example, the data that is required for performing step B1 730 may not be accessible, may be missing, may be corrupted. Other reasons may be that step B1 730 requires following certain steps that are not allowed based on the policies of the enterprise. Whatever the reason may be, the generative AI system, such as by using the control circuitry 220 and/or 228, may investigate or troubleshoot what is causing the error, and determine a revised or updated workflow 720 to perform the task requested. As depicted in the revised workflow 720, the generative AI system, such as by using control circuitry 220 and/or 228, having determined that step B1 730 is causing the problem or error, may revise the workflow to perform steps B4-B7 750-780 instead of step B1 730 to get to the next step in the workflow B1-1 740. To generate the revised workflow, the generative AI system, such as by using control circuitry 220 and/or 228, may once again leverage the knowledge base, apply deep learning techniques to intuitively learn, and, without user intervention, determine different strategies and approaches to accomplish the same functions by bypassing step B1 730 that was causing the errors. In that regard, the generative AI system, such as by using control circuitry 220 and/or 228, may also, without user intervention, query internal systems of the enterprise to understand other viable paths possible, test and troubleshoot the other viable paths, and then generate a workflow with the new path. For example, in FIG. 9, if one branch or path is not working, giving an error, or taking longer to execute, then a different path or branch may be followed to get the results needed.

FIG. 8 is a block diagram of a user interface for simultaneously displaying an interactive conversation and the generated workflow, in accordance with some embodiments of the disclosure. The interactive conversation and the workflow generated may be implemented, in whole or in part, by systems or devices such as those shown in FIGS. 2-3. One or more actions related to interactive conversation and the workflow generated may be incorporated into or combined with one or more actions of any other process or embodiments described herein.

In some embodiments, a user interface that displays an interactive conversation 805 and workflow generated 810 may be displayed on a user's device. In some embodiments, at time t=t₀ the user may provide an input. For example, the input 815 may indicate that the user would like to build a persona for XYZ.

In response to receiving the user input 815, the generative AI system, such as by using control circuitry 220 and/or 228 and generating an AI agent or AI bot, at time t=t₁ may ask a follow up question 820, such as what tasks does a person with persona XYZ do? In some embodiments, at any time during the interactive conversation, if a determination is made that a specific piece of information or data is needed from the user to perform the task, then the generative system, using an AI agent or bot may ask the user, e.g. by displaying a response to the user input, for the specific piece of data needed.

The question, i.e. what tasks does a person with persona XYZ do, may be presented for the generative AI system to determine what type of workflow model to generate and the persona template to create. For example, a user who is an assistant may have a different skill set, different level of understanding, and different job functions as another user who is a manager or vice president. As such, a customized workflow and persona template that can be usable and understood by the user based on their skill and job function may be generated. Although the workflow for performing a task may be similar, in some embodiments, the design and flow of the persona template may differ and be customized to the user based on their skill, job function, understanding, etc.

At block 825, the user may provide a response to the system query 820 and indicate, at time t=t₂ that the tasks performed are tasks A, B, and C. In real-time (accounting for any network delay) while the interactive conversation is in progress, the generative AI system, such as by using control circuitry 220 and/or 228, in the backend may access the knowledge base, apply deep learning techniques, determine tasks and sub-tasks to be completed, determine steps and sub-steps and processes needed to complete the task, and generate a workflow relating to the input received thus far (i.e. input 815-825). All the backend steps may be performed simultaneously and in real-time while the conversation is still occurring. The time between input and response may also be, in some embodiments, in seconds of micro seconds without any user intervention.

At time t=t₂ the UI may display, such as on the right side, Workflow A, which corresponds to performing the tasks requested/provided at block 825. The generative AI system, such as by using control circuitry 220 and/or 228, may also inform the user at time t=t₃ that the persona template for doing tasks A, B, and C has been prepared, as depicted at 830. Generating Workflow A may require several steps, processes, implementations, calculations, workflow strategy determinations, debugging of code, etc. It may also require the generative AI system to perform a feedback loop, repeating steps, reorder the sequence of steps etc., to obtain the desired result. In some instances, it may require a series of complicated steps, such as the steps depicted at block 910 in FIG. 9.

At time t=t₄ the user viewing the workflow A generated, which is displayed in the user device's UI, may ask another question, or provide another input 840. The input, in one embodiment, may ask or request if the output can be in a certain format. The input 840 may specify either generally or specifically the format desired.

In real-time, while the interactive conversation is in progress, the generative AI system, such as by using control circuitry 220 and/or 228, may perform backend processes to determine tasks and sub-tasks that are required to generate the output in the desired format as requested at block 840. The generative AI system, such as by using control circuitry 220 and/or 228, may then add to the already generated workflow A, additional steps, such as Workflow B, that are to be used to generate the output in the desired format. To generate Workflow B, a series of steps, processes, implementations, calculations, workflow strategy determinations, debugging of code, etc. may be required, e.g., such as the steps depicted at block 920 in FIG. 9.

At time t=t₅ the UI may display, such as on the right side, Workflow B, which corresponds to outputting in the format requested at block 840. The generative AI system, such as by using control circuitry 220 and/or 228, may also inform the user at time t=t₅ that the steps to output in the desired format have been prepared, as depicted at 845.

At time t=t₆ the user viewing the workflow A generated may ask another question, or provide another input 855. The input, in one embodiment, may ask if the persona can answer questions relating to topics D and E.

In real-time, while the interactive conversation is in progress, the generative AI system, such as by using control circuitry 220 and/or 228, may perform backend processes to determine all the steps that would need to be executed to allow the user to ask questions relating to topics D and E and obtain answers. To do so, the generative AI system, such as by using control circuitry 220 and/or 228, may have to perform a series of steps, processes, implementations, calculations, workflow strategy determinations, debugging of code, etc. For example, the generative AI system may have to access several databases, ensure that the person asking the question will have permission to access those databases, if not, obtain such permission, etc. Since answering questions related to topics D and E is not a single task, i.e., several different types of questions may be presented under the umbrella of topics D and E to be answered, a whole system, strategy, application, an methodology would need to be determined and implemented automatically by the AI system for it to answer any question under the topics D and E.

At time t=t₇ the UI may display, such as on the right side, Workflow C, which corresponds to the request to be able to answer questions relating to topics D and E. The generative AI system, such as by using control circuitry 220 and/or 228, may also inform the user at time t=t₇ that the steps to answer questions related to topics D and E have been configured and the system is ready for use for such purpose.

Although the UI is depicted displaying interactive conversation on the left and the workflow generated on the right, the embodiments are not so limited. Other formats, layouts, sequence of steps, and UI designs may also be used to perform the steps described. Layout which allows sub steps of Workflows A and B, e.g., as depicted in FIG. 9, may also be displayed when a user selects the Workflow A or B or hivers over them. A display that is collapsible, such as displaying sub steps of a workflow when you select or hover and then collapse back to Workflow A when no longer selected or hovered upon is also contemplated within the embodiments.

FIG. 9 is an example of sub-workflows and steps involved in the sub-workflows to perform an enterprise task, in accordance with some embodiments of the disclosure. As described earlier, each workflow step, such as Workflow A, Workflow B, and workflow C in FIG. 8, which are steps or sub steps within the larger workflow 810 generated, may require several steps, processes, implementations, calculations, workflow strategy determinations, debugging of code, accessing of different databases, and using different methods to obtain authorizations and access to such databases and performing other functions depending on what task is to be completed. In some embodiments, each workflow step may have different requirements that need to be performed in order to proceed to the next workflow step.

Workflow A 910 is one example of the tree or nodes of steps that may be performed to perform a given/requested task. As it can be seen in FIG. 9, the tree may have several branches and even loops, e.g. loop of steps 3, 4, and 5, to perform the task. The number of branches and nodes that represent steps to be performed may vary on a case-by-case bases from steps 1-n. Even each branch may have n number of steps depending on what task or sub-task is to be accomplished by steps in that branch. As described earlier, each workflow step, such as Workflow A and Workflow B 920, may have steps to complete a task. As depicted, Workflow B has a different set of steps represented in a tree/nodes sequence than Workflow A. The workflow on a whole 810, as well as each workflow step, e.g. 835, 850, 865, 910, and 920, may be generated based on processing the conversational input, applying deep learning to leverage data in the knowledge base, and generating the steps.

FIG. 10 is an example of types of data that may be gathered by the system to generate a persona template, in accordance with some embodiments of the disclosure. Some examples of categories of data that may be obtained by the generative AI system may include determining the use case 1010, industry 1020, person/role 1030, access level 1040, and output type 1050. These are only exemplary categories and additional categories of data may also be obtained from the user or through other means (e.g., emails, texts, databases, application, employee files, HR databases, online sources and accounts, etc.) depending on the type and nature of the task to be completed.

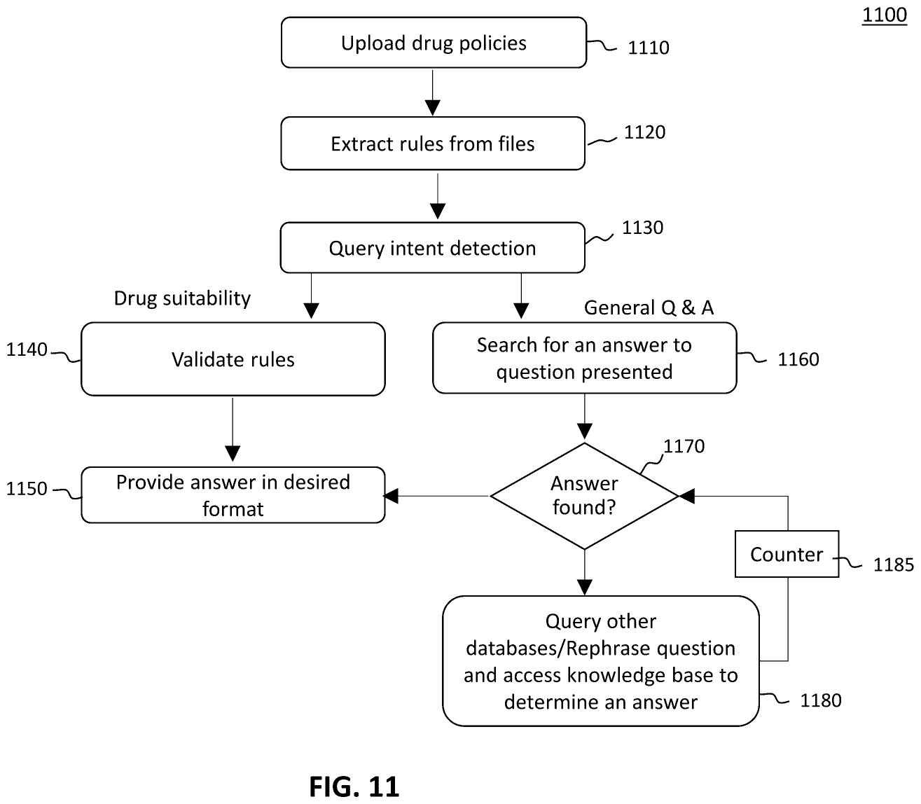

FIG. 11 is flowchart of an example of a process for using a conversational input to generate a workflow for a pharmacy assistant and perform an enterprise task, in accordance with some embodiments of the disclosure. Process 1100 may be implemented, in whole or in part, by systems or devices such as those shown in FIGS. 2-3. One or more actions of the process 1100 may be incorporated into or combined with one or more actions of any other process or embodiments described herein. The process 1100 may be saved to a memory or storage (e.g., any one of those depicted in FIGS. 2-3) as one or more instructions or routines that may be executed by a corresponding device or system to implement the method 1100.

In some embodiments, processes 800 from FIG. 8 may be applied to any industry or domain. It may also be automatically customized by the generative AI system without user intervention to a particular domain, such as the example of FIG. 11 and process 1100 which is related to a pharmacy domain.

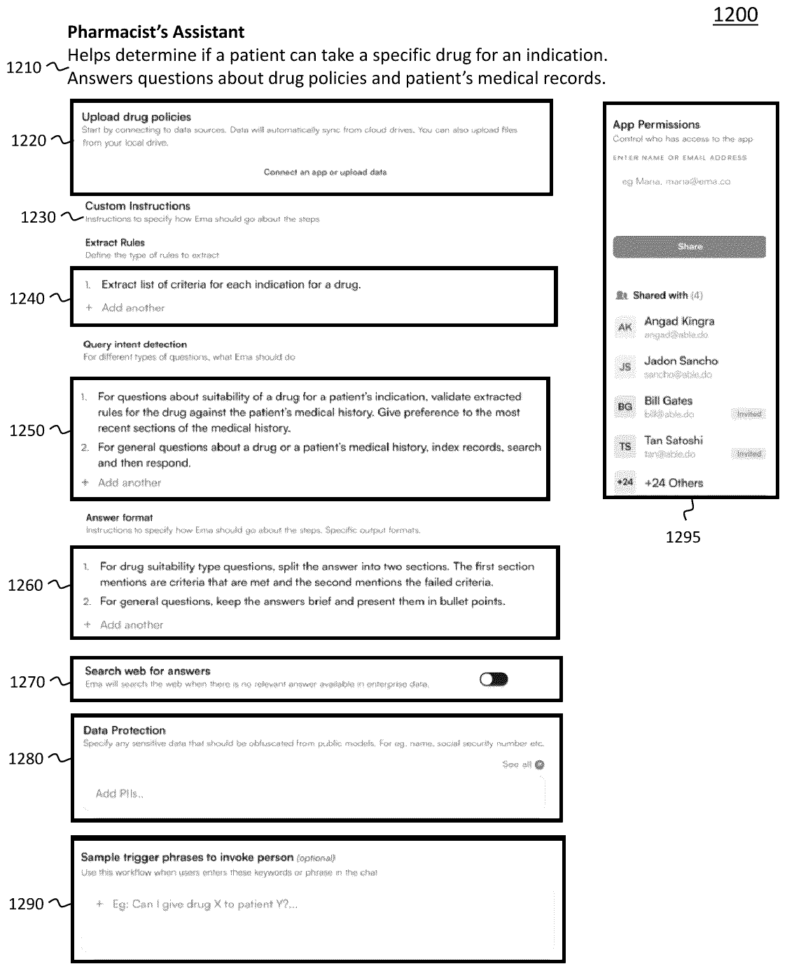

Process 1100 in FIG. 11, in some embodiments may be a workflow that is generated based on an interactive conversation, such as the interactive conversation depicted in FIG. 8, with a persona, such as a pharmacy assistant in this case. For example, based on a conversational input, the generative AI system may determine that the persona 1030 for the task to be completed is a pharmacy assistant and the use case 1010 is for the pharmacy assistant to answer questions about drug policies and patient's medical records, the industry or domain 1020 is a pharmacy, the access level 1040 needed for this task is for the workflow to be able to access medical records to answer related questions, and the output type 1050 should be in a form where the pharmacy assistant can provide answers to questions relating to drug policies and patient's medical records. If the same task were to be performed by another persona, such as a more senior pharmacy technician, or a manager of the pharmacy, although the workflow may be similar, the generative AI system, based on either the conversational input, or other materials accessed (e.g., emails, texts, databases, application, employee files, etc.), may determine the persona and create a different persona template, such as the exemplary persona template depicted in FIG. 12.

In this embodiment, the process 1100 may include uploading drug policies at block 1100. This may require accessing different drug companies' databases or websites and online materials to obtain the drug policies. Such policies may also already be stored in the knowledge base, in which case, the knowledge base may need to be accessed.

At block 1120, rules from the files related to drug policies may be extracted and queried at block 1130, such as for various reasons, such as compliance of rules or intent detection. Workflow may be generated that determines drug suitability for a patient of for answering general questions or questions specific to drug suitability.

At block 1140 rules may be validated and an answer relating to drug suitability may be provided at block 1150 in a desired format for the persona.

At block 1160, the workflow may be designed to search for an answer for a question presented, such as by the pharmacy assistant. The steps taken in the workflow to obtain the answer may include blocks 1170-1180 in which a determination is made at block 1160 if an answer to the question presented can be found. In some embodiments, a determination may be made at block 1170 that the answer cannot be found, which may be due to many reasons, such as the answer is not available in a queried database, access to a database is not authorized, the answer does not exist, the answer is outdated etc. In such a circumstance, the workflow may be designed to automatically troubleshoot the reason why the answer cannot be obtained, figure out other solutions to obtain an answer, such as by querying different database, obtaining information from multiple sources and applying deep learning to generate an answer that previously did not exist, etc. In some instances, the workflow may be designed to repeat steps 1170 and 1180 for a number of iterations of until the counter hits a predetermined number, such as 2 or 3 iterations. If an answer cannot be found, the workflow may automatically evolve without user intervention to using different steps to get the answer for the question presented, such as improvising or extrapolating based on learning from data in the knowledge base. Once the answer is determined, it may be presented at block 1150 in the desired format.

FIG. 12 is an example of a persona template, in accordance with some embodiments of the disclosure. The persona template may be generated for a specific persona (e.g., person/role 1030) that is learned by the generative AI system either based on either the conversational input, or other materials accessed (e.g., emails, texts, databases, application, employee files, etc.). Since each persona may have a different skill set and different use case, the methods and systems may automatically generate a UI that is suitable for that specific persona. For example, a persona template for an assistant may be different than a persona template for a manager (e.g., it may have more tools, more data configuration options, etc.)

As described earlier, although the workflow for performing a task may be similar, in some embodiments, the design and flow of the persona template may differ and be customized to the user based on their skill, job function, understanding, etc.

In some embodiments, using the persona template 1200, the user of the workflow (or the application that includes the generated workflow) may be able to configure or customize the workflow (or the application that includes the generated workflow), as depicted at block 140 in FIG. 1. Such customizations may include inputting enterprise specific data, inputting enterprise specific procedures and policies, providing direction on format and output, providing input on how the result of the task should be presented, providing input realign to which other employees the output should be shared with, and any other customization desired.

It will be apparent to those of ordinary skill in the art that methods involved in the above-mentioned embodiments may be embodied in a computer program product that includes a computer-usable and/or-readable medium. For example, such a computer-usable medium may consist of a read-only memory device, such as a CD-ROM disk or conventional ROM device, or a random-access memory, such as a hard drive device or a computer diskette, having a computer-readable program code stored thereon. It should also be understood that methods, techniques, and processes involved in the present disclosure may be executed using processing circuitry.

The processes discussed above are intended to be illustrative and not limiting. More generally, the above disclosure is meant to be exemplary and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

What is claimed is:

1. A method comprising:
interactively conversing with a user to obtain information relating to an enterprise task to be performed, a domain related to the enterprise task, and a persona of the user;
accessing and leveraging data in a knowledge base using a deep learning technique to generate a workflow for the enterprise task to be performed;
automatically generating the workflow for performing the enterprise task based on the data leveraged from the knowledge base using the deep learning technique; and
displaying the generated workflow on a user interface to the user.

2. The method of claim 1, further comprising, generating the user interface on an electronic device of the user, wherein the generated user interface displays both the interactive conversation between the user and a generative artificial intelligence (AI) system and the workflow generated for performing the enterprise.

3. The method of claim 1, further comprising:
generating the workflow in a backend in real-time during progress of the interactive conversation; and
displaying the generated workflow simultaneously during progress of the interactive conversation.

4. The method of claim 3, wherein displaying the generated workflow simultaneously during progress of the interactive conversation further comprises:
receiving a first conversational input from the user, wherein the first conversational input is associated with the interactive conversation;
displaying the workflow generated on a user interface of the user,
wherein the workflow generated relates to a topic of the first conversational input, is displayed simultaneously while providing a response to the first conversational input, and is displayed before receiving a second conversational input from the user.

5. The method of claim 1, further comprising:
generating a persona template, wherein the persona template is used for configuring the generated workflow by inputting enterprise data; and
receiving a configuration from the user, wherein the configuration is inputted via the generated persona template.

6. The method of claim 5, wherein the persona template is associated with a persona of the user, wherein the persona includes the any one or more of a skill set of the user, a job function of the user, or an enterprise job title of the user.

7. The method of claim 1, wherein the workflow generated includes a plurality of steps that when executed perform the enterprise task.

8. The method of claim 1, further comprising:
automatically testing the generated workflow; and
automatically revising the generated workflow when a step of the workflow cannot be implemented.

9. A method comprising:
receiving a conversational input from a user related to generating a software application for performing an enterprise function;
analyzing the received conversational input to a) determine the enterprise function to be performed and b) a persona for the application;
learning based on relevant data from a knowledge base, wherein the data in the knowledge base relates to the enterprise function to be performed;
determining steps of a workflow to perform the enterprise function based on the learning from the relevant data from the knowledge base; and
automatically generating a software application having the workflow for performing the enterprise function, wherein the workflow includes the determined steps.

10. The method of claim 9, further comprising:
providing user interface tools for configuring the generated software application; and
deploying the software application after its configuration.

11. The method of claim 9, further comprising:
generating a user interface on an electronic device of the user; and
displaying the generated workflow on one portion of the user interface and the conversational input in a separate portion of the user interface.

12. The method of claim 10 further comprising:
analyzing the received conversational input related to generating a software application;
determining that a specific piece of information is needed to perform the enterprise function provided in the received conversational input;
automatically, using an artificial intelligence (AI) bot, responding to the received conversational input, wherein the response queries the user for the specific piece of information is needed to perform the enterprise function.

13. A generative artificial intelligence (AI) system comprising:
communications circuitry configured to receive conversational inputs from a user device; and
control circuitry configured to:
interactively converse with the user device to obtain information relating to an enterprise task to be performed, a domain related to the enterprise task, and a persona of a user associated with the user device;
access and leverage data in a knowledge base using a deep learning technique to generate a workflow for the enterprise task to be performed;
automatically generate the workflow for performing the enterprise task based on the data leveraged from the knowledge base using the deep learning technique; and
display the generated workflow on a user interface of the user device.

14. The system of claim 13, further comprising, the control circuity configured to generate the user interface on the user device, wherein the generated user interface displays both the interactive conversation between the user device and a generative artificial intelligence (AI) system and the workflow generated for performing the enterprise.

15. The system of claim 13, further comprising, the control circuity configured to:
generate the workflow in a backend in real-time during progress of the interactive conversation; and
display the generated workflow simultaneously during progress of the interactive conversation.

16. The system of claim 15, wherein displaying the generated workflow simultaneously during progress of the interactive conversation further comprises, the control circuity configured to:
receive a first conversational input from the user device, wherein the first conversational input is associated with the interactive conversation;
display the workflow generated on a user interface of the user device,
wherein the workflow generated relates to a topic of the first conversational input, is displayed simultaneously while providing a response to the first conversational input, and is displayed before receiving a second conversational input from the user device.

17. The system of claim 13, further comprising, the control circuity configured to:
generate a persona template, wherein the persona template is used for configuring the generated workflow by inputting enterprise data; and
receive a configuration from the user device, wherein the configuration is inputted via the generated persona template.

18. The system of claim 17, wherein the persona template is associated with a persona of the user associated with the user device, wherein the persona includes the any one or more of a skill set of the user, a job function of the user, or an enterprise job title of the user.

19. The system of claim 13, wherein the workflow generated by the control circuity includes a plurality of steps that when executed perform the enterprise task.

20. The system of claim 13, further comprising the control circuity configured to:
automatically test the generated workflow; and
automatically revise the generated workflow when a step of the workflow cannot be implemented.
